(19) United States
(12) Patent Application Publication
(10) Pub. No.: US 2004/0155888 A1
(43) Pub. Date: Aug. 12, 2004

(54) Method for displaying the contents of a collection of media objects

(76) Inventors: David Gary Padgitt, Schaumburg, IL (US); Kevin B. Lacey, Oak Park, IL (US); Niels Clausen-Stuck, Chicago, IL (US)

Correspondence Address: Howard E. Silverman, GREENBERG TRAURIG, P.C., Suite 2500, 77 West Wacker Drive, Chicago, IL, 60601, US

(21) Appl. No.: 10/364,072

(22) Filed: Feb. 11, 2003

(51) Int. Cl. G09G 5/00

(52) U.S. Cl. 345/619

(57) ABSTRACT

A method for displaying the contents of a collection of media objects having one or more associated identifying parameters. Visual images are associated with each media object and the visual images are displayed in an arrangement that is determined at least in part by the one or more parameters associated with the media object with which the visual image is associated.

### BACKGROUND OF THE INVENTION

This invention relates generally to electronic devices for playing media objects and, more particularly, relates to a graphical user interface for displaying a collection of media objects. The graphical user interface may be used to command an electronic device to access one or more of the collection of media objects.

In the case of at least digitally stored media objects, such as audio recordings, video recordings, etc., information about the digitally stored recordings is typically maintained within a database. Devices for playing the digitally stored recordings enable access to the digitally stored recordings, for example, by allowing a user to scroll through a list of information retrieved from the database typically presented as text, from which the consumer may then access a digitally stored recording of interest. However, as the amount of information within the database increases, consumers often time find that it is consuming and frustrating to locate information concerning the contents of their library of media objects.

The advent of MP3 audio technology, MP3 players and the almost commonplace existence of personal computers has lead to an explosive growth in the number of consumers and indeed professionals who maintain their collection of audio albums and compact discs as digital files stored on media such as a computer hard drive. The huge capacity of a modern consumer hard drive, and other storage media, has made it possible for the consumer to convert an entire collection of thousands and thousands of songs, residing on LP's and CD's, into digital audio files which can be stored digitally and then later randomly accessed for conversion into audible sound at the user's command. Entire collections of LP's and CD's can now be easily stored, accessed and played using commonplace computer hardware and software or any one of the increasingly available dedicated digital audio devices, such as an MP3 player or jukebox.

One significant drawback to the ability to amass an entire collection or library of digital audio or video medial objects, is the need to conveniently identify, access and search one's library. Prior art database management tools, and in particular, audio and/or video media object managers almost exclusively rely upon a primarily textual interface.

Accordingly, a need exists for an improved user interface that allows a user to quickly and easily view the contents of a media object library. A need also exists for a user interface that presents information concerning media objects in a manner that is meaningful to the consumer.

### SUMMARY OF THE INVENTION

In order to address these and other needs, described hereinafter is a method for displaying the contents of a collection of media objects having one or more associated identifying parameters. Generally, visual images are associated with each media object and the visual images are displayed in an arrangement that is determined at least in part by the one or more parameters associated with the media object with which the visual image is associated. By way of more specific example, the method may be used to display the contents of a collection of audio recordings where such recordings are stored in a digital format on a randomly accessible storage medium and where each stored audio recording has an embedded tag including at least two parameters identifying each stored audio recording. Again, visual images are provided that represent each stored audio recording and the entire collection of audio recordings may be displayed to a consumer by grouping together in clusters those visual images representing audio recordings having the same primary parameter. In this manner, the consumer is presented with a topographical view of the collection of audio recordings which, among other things, permits the consumer to immediately perceive the relative size of the collection by parameter type and refine one's search for desired audio recording.

A better understanding of the objects, advantages, features, properties and relationships of the graphical user interface will be obtained from the following detailed description and accompanying drawings which set forth an illustrative embodiment which is indicative of the various ways in which the principles of the graphical user interface may be employed.

### BRIEF DESCRIPTION OF THE DRAWINGS

For a better understanding of the graphical user interface, reference may be had to a preferred embodiment shown in the following drawings in which:

FIG. 1 illustrates an exemplary device for accessing media objects in the form of an MP3 player having a graphical user interface constructed in accordance with the principles of the subject invention;

FIGS. 2-6 illustrate the graphical user interface of FIG. 1 at various levels of zoomed-in detail; and

FIGS. 7-12 illustrate examples of images used to represent media objects within the graphical user interface.

### DETAILED DESCRIPTION

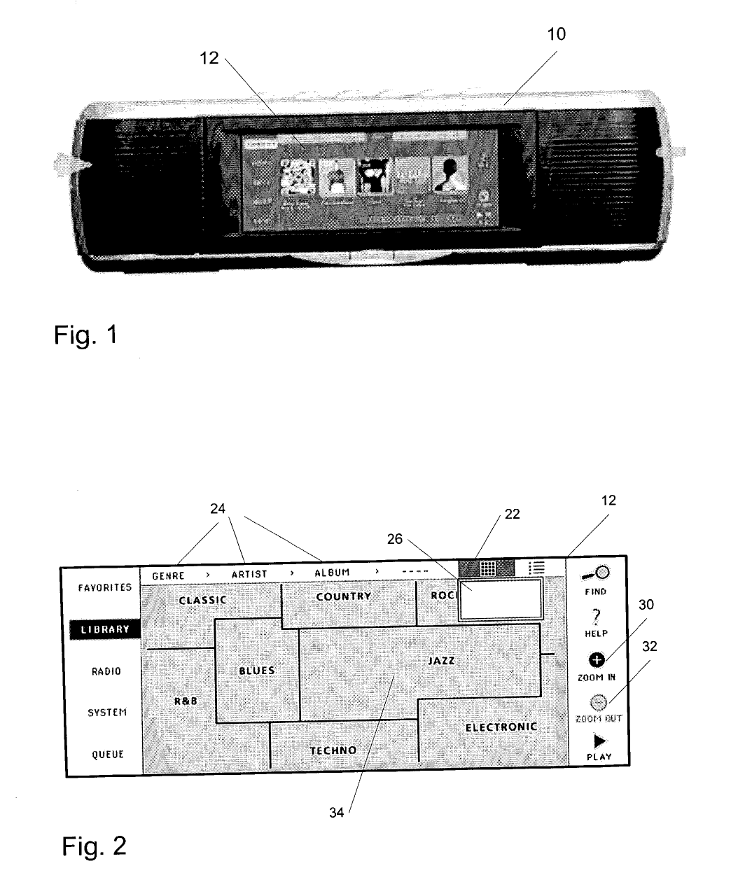

Referring now to the figures, wherein like reference numerals refer to like elements, a graphical user interface for displaying the contents of a collection of media objects is described. In the description that follows, it is to be understood that media objects comprise, by way of example, digitally stored images, digitally stored audio or video recordings, and/or broadcast content such as television, radio, or streaming data, individually or collectively, for example, by being related according to genre, sub-genre, artist, play list, etc. The graphical user interface described hereinafter may also be used in connection with a microprocessor based electronic device 10 to command the electronic device 10 to play or otherwise process one or more of the media objects. To this end, the microprocessor based electronic device 10, for example, an MP3 player as illustrated in FIG. 1, may include an integrated or detachable display 12 that is used to present the graphical user interface to a consumer. Alternatively, the graphical user interface could be displayed to the consumer in a further electronic device that is remote from the electronic device 10, for example, a television, a monitor screen, a remote control, or the like, that is adapted to communicate with the electronic device 10. Interaction with the graphical user interface, whether local or remote to the electronic device 10, is accomplished using conventional graphical user interface devices, such as a mouse, keyboard, wireless pointer, touch screen, or the like.

For the purpose of displaying the contents of a collection of media objects using the graphical user interface, the electronic device that supports the graphical user interface is provided with access to a database in which is maintained parameters by which individual ones of the collection of media objects are identifiable. By way of example, parameters that are used to identify one or more of the media objects may include global titles (e.g., album or movie titles), track titles, artist/actor names, distributor information (e.g., label information), beats per minute, run time, credits, year recorded or published, genre, metagenre, subgenre, languages, notes, etc. In the case of audio files, parameters may be related to the ID3 data that is associated with an audio file. While the parameters are useful for searching within and filtering the contents of a collection of media objects, the parameters are also useful to allow for the quick identification of the media objects when they are represented in the graphical user interface display.

For use in quickly identifying a unique or logical group of media objects within the graphical user interface display, media objects are represented within the graphical user interface using images. Preferably, each image provides a visual or textual indication as to the one or more parameters that are associated with the media object the image represents. For example, an image 14 may take the form of the actual visual image that appears on the physical album cover or CD jewel box from which its corresponding media object originated, an example of which is illustrated in FIG. 8. Since the actual visual image that appears as cover art on an album, movie, or book is typically unique, such images are desirable as they function to identify the parameters of a media object, i.e., movie or album title, song title, artist name, etc., without the need for any textual indicia.

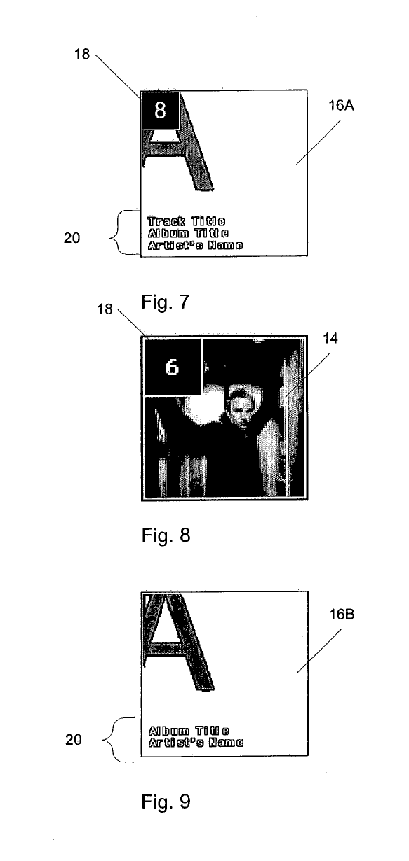

To provide the system with a relatively unique image that will be associated with a media object, which image would also be maintained within the database, the consumer can load an image into the system, for example, by uploading a scanned original album cover or CD jewel box insert, a bitmap image, etc. The user can additionally provide their own image which may have no relationship to the original album cover or CD jewel box insert, but which nevertheless serves to indicate to the user the identity of or otherwise signify the media object. Where cover art is not available or the user elects not to use uploaded art, a generic visual image 16 can be provided by the graphical user interface. In keeping with the desire to uniquely identify individual or logical groups of media objects, a generic image 16 can be selected and/or edited to convey one or more dominant parameters of the media object it is to represent within the graphical user interface. By way of example, FIG. 7 illustrates a sample generic image 16A that represents a media object such as a particular song or track of an album. In the illustrated example, in place of the album cover art, the generic image 16 includes the letter “A,” which signifies that generic image 16 represents a media object that originated from an album. The visual image may also include a rectangular box 18 that functions to identify a media object that corresponds to a specific song or track from an album, movie, or the like. The track information may be automatically inserted into an image when appropriate or provision may be made to allow for manual insertion of such information.

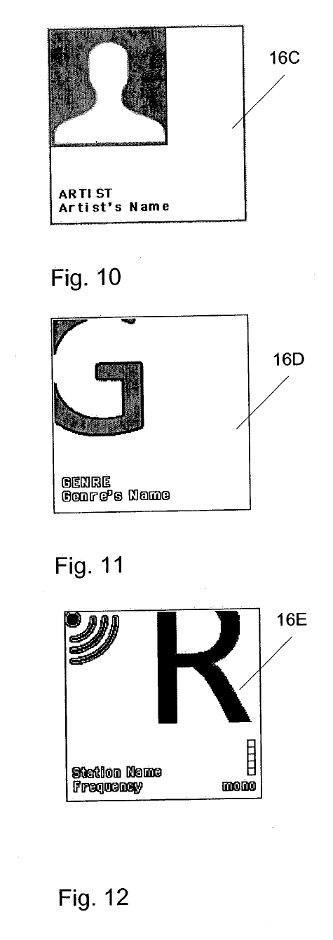

The system may also be adapted to allow the consumer to manually enter textual labels 20 into an image to provide a song or track name, an artist name, an album or movie name, etc, by which an image representative of a media object is readily identifiable. The software supporting the user interface may alternatively automatically generate such generic images and add textual labels 20 based upon the parameters associated with the media object. By way of further example only, generic images 16 may also be used to represent media objects in the form of: an entire album 16B (illustrated in FIG. 9); recording(s) by an artist 16C (illustrated in FIG. 10); recording(s) by genre 16D) (illustrated in FIG. 11); a radio station 16E (illustrated in FIG. 11); etc. without limitation. Images may also be provided with unique visual indicia such as coloring, symbols, stylizations, etc. to further assist in uniquely identifying an image and its corresponding media object.

To allow access to the media object through use of the graphical user interface, the system can be configured to automatically associate a visual image with a corresponding media object. In addition, the system may allow for the consumer to manually associate an image with a media object. As will be appreciated, access to a media object via the graphical user interface can be used to cause the playing, deleting, moving, etc. of the media object by an electronic device 10.

The database in which the parameters and images are maintained (and the collection of media objects—when the media objects are digitally stored and in the case where the electronic device 10 is also adapted to provide access to the media objects) may be local to the electronic device that supports the graphical user interface or the database may be a component in a distributed system where the electronic device that supports the graphical user interface is in remote communication with the database. It will be appreciated that such a database may itself be distributed within any such network. By way of example, the database may be stored in a PC, hard drive array, network, or one or more remote computers accessible via the Internet with which an electronic device is adapted to communicate.

For use in displaying the images representative of the collection or library of media objects in a manner that is meaningful to the consumer, the graphical user interface includes a selectable icon 22, illustrated by way of example in FIG. 2, the activation of which causes the electronic device that supports the graphical user interface to access the database to retrieve the images for ultimate display by the graphical user interface. Once the image data is retrieved, the images corresponding to the collection of media objects may be displayed in an arrangement that is arrived at as a function of one or more specified and/or default parameter types, for example, by genre, by artist, by album etc. Preferably, the graphical user interface presents selectable icons, a pull-down menu 24, or the like by which the consumer can specify by which parameter the images are to be arranged when the images are displayed within the graphical user interface.

At the highest level of display, the images are displayed and arranged using a jigsaw puzzle-like topographical map in which the overall collection of images representative of a library of media objects is presented to the user. In the example illustrated in FIG. 2, this topographical map presents the images in categorical areas where the images are grouped into clusters as a function of the genre parameter that is associated with the image and the media object that the image represents. The graphical user interface may also provide a navigator map 26 that represents the overall boundaries of the display wherein an indicator 28, an example of which is illustrated in FIGS. 4 and 5, represents a proportional area of the overall display which is currently being viewed. Since the topographical map view displays the entirety of the image/media object collection, the indicator 28 covers the entire navigator map 26 as seen in the example illustrated in FIG. 2.

For navigating the display of images, the graphical user interface provides for zooming, panning, dragging and selecting. Panning is the mechanism by which the images are moved such that different portions of the overall collection are brought into view within the display. A particular view can be panned to the edge of the display screen such that the further a view is zoomed out, the less of the view that may be panned. At the maximum out zoom level, i.e., the view using the topographical map, panning is no longer available since the entire image collection is being shown. When the image display is being panned, any movement of the viewable area by means of the panning should be reflected in the navigator map 26.

To allow the consumer to easily perform a panning operation, the graphical user interface is responsive to a movement in a given direction to pan the display in a corresponding direction. Movement may be indicated to the graphical user interface, for example, by moving a finger over a touch screen display, via interaction with a scroll bar, etc. The graphical user interface may also be responsive to a push gesture to cause an automatic panning until such time as a stop gesture is provided, a given time expires, or an end of the display is reached. Movement can thus appear to slow down similar to movement which ceases due to friction.

To indicate a desire to cause the display to provide a zoomed-in or zoomed-out view of the images, the consumer may interact with either a zoom-in button 30 or zoom-out button 32 that is provided with the graphical user interface. An exemplary zoom-in progression is illustrated in FIG. 2 through FIG. 6. When the maximum zoom-out level is reached, the zoom-out button 30 may be grayed, faded, or the like to indicate that no further zooming-out is permitted in that direction, as seen in FIG. 2. Similarly, when the maximum zoom-in level is reached, the zoom-in button 32 may be grayed, faded, or the like to indicate that no further zooming-in is permitted. When zooming-in, it may be preferred to maintain the center of the display on the center of the display of images currently being viewed. When zooming-out, it may be preferred to keep the view centered on the center of the display of images currently being viewed until such time as the entire image set is displayed.

A zooming-in operation may also be performed by the consumer tapping, for example twice, within the display of images displayed on a touch screen display. In this case, the zooming-in operation may cause the next display of images to be centered about the location that was tapped. Still further, in certain circumstances, it may be desired to cause the next display of images to be centered about the center of a displayed category area, e.g., “jazz,” as illustrated in FIG. 2, that was tapped.

By way of more specific example, FIG. 2 illustrates a topographical view of the images arranged as a function of a genre parameter such that the number of media object images that are displayed within a given parameter category area (e.g., “genre”) defines the size of that parameter category area. Thus, in the illustrated example, it is seen that there exists a large number of media objects that fall within the “jazz” genre parameter category area when compared to those media objects that fall within the “blues” genre parameter category area. To allow for the easy discernment of the parameter areas, one or more lines may be used to separate images having one or more compatible parameters from those images not having the one or more compatible parameters. As noted previously, this dynamically created topographical view is dependent upon the specific parameters that are used to identify and define each media object. It will also be appreciated that the topographical view illustrated in FIG. 2 illustrates the maximum zoomed-out view for the collection of images representative of the collection of media objects. Since specific details of the images may be lost in this maximum zoomed-out view, which details would normally function to identify one or more parameters of a media object, it is useful to provide textual labels 34 that indicate the parameter categories by which the images are being arranged and displayed. In addition, each media object is represented by a square symbol, not unlike the overall shape of a CD jewel box, which due to size limitations are colored gray.

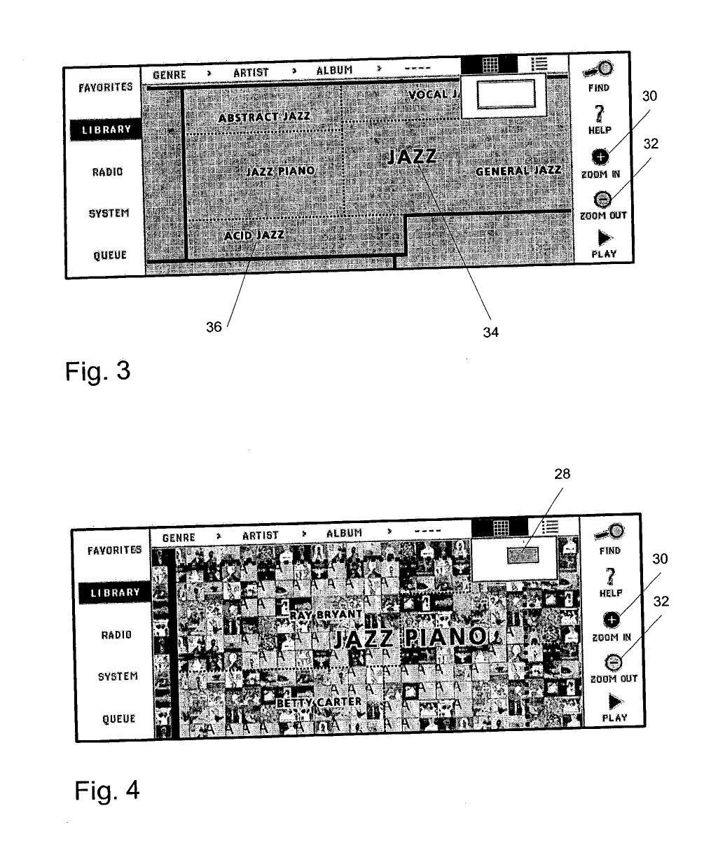

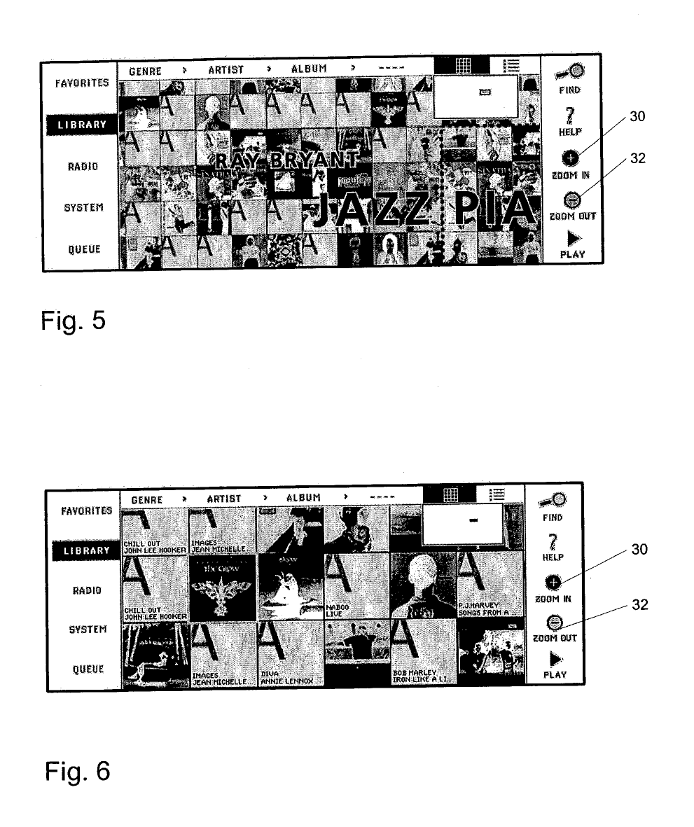

Sub-genre levels may likewise be viewed and manipulated. For example, zooming-in from the genre image view illustrated in FIG. 2 may result in the display of the images that shows an arrangement that was made as a function of a sub-genre parameter as illustrated in FIG. 3. In this illustrated example, the images are arranged and clustered according to sub-genres such as “jazz,” “jazz piano,” “general jazz,” etc. Again, since specific details of the images may be lost in this view and each object displayed as a gray square, it is may useful to provide textual labels 34, 36 that indicate the parameter categories used to arrange and cluster the images, e.g., the genre and sub-genres. Zooming in yet again by any of the available methods causes the display to drill down one more level where the images may be displayed to illustrate clustering in accordance with still further parameters, for example, by artist as well as by genre and sub-genre as illustrated in FIG. 4. At this drill down level, since the images are more discernable, it may be desirable to omit any textual labels that indicate the parameters by which the images are arranged as the images may be of a size such that each is clear enough to provide the information on their own behalf, e.g. by displaying the Album or CD cover art or generic image. Zooming-in still further, as illustrated in FIGS. 5 and 6, will cause the display and clustering of the images to become increasing more focused while narrowing the amount of images presented to the user. Zooming may continue in this manner until the “lowest” parameter is reached or a level is reached where the graphical details of the images are very discernable, i.e., the system reaches the maximum zoom-in level where even the labels provided to images including generic images are discernable as is illustrated in FIG. 6. Images at this level, and category objects/images at other levels, may be selected using conventional graphical user interface techniques, for example, to cause an electronic device 10 to “open” and play a media object represented by a selected image. While not implemented in the preferred embodiment of the invention, images could also be manipulated at this level to, for example, instruct the electronic device 10 to cause media objects to be added to a favorites lists or queues, to be deleted from the system, etc.

While specific embodiments of the invention have been described in detail, it will be appreciated by those skilled in the art that various modifications and alternatives to those details could be developed in light of the overall teachings of the disclosure. For example, while described in the context of digitally stored recordings, those of skill in the art will appreciate that the graphical user interface described herein may be equally used to provide access to virtually any collection of content including, for example, a library maintained in an analog format (e.g., where an appropriate intermediary mechanism or jukebox serves to permit access to any content desired to be viewed or played). Accordingly, the particular arrangement disclosed is meant to be illustrative only and not limiting as to the scope of the invention which is to be given the full breadth of the appended claims and any equivalents thereof.

What is claimed is:

1. A method for displaying the contents of a collection of media objects, the method comprising:
providing media objects each having one or more associated identifying parameters;
providing a visual image associated with each media object;
displaying the visual images in an arrangement that is determined at least in part by the one or more parameters associated with the media object with which the visual image is associated.

2. The method according to claim 1, in which the step of displaying the visual images is further comprised of the step of displaying the visual images associated with media objects having one or more compatible parameters in a contiguous arrangement.

3. The method according to claim 1, the method further comprising the step of displaying grouping information identifying the parameter associated with the set of visual images having one or more compatible parameters.

4. The method according to claim 3, in which the step of displaying grouping information is further comprised of the step of displaying one or more lines separating images having one or more compatible parameters from images not having one or more compatible parameters.

5. The method according to claim 3, which method further comprises the step of displaying text indicative of the one or more compatible parameters.

6. The method according to claim 5, in which the step of providing one or more parameters associated with each media object comprises the step of providing a parameter indicative of the genre of each audio recording and the step of displaying text is comprised of the step of displaying text descriptive of the genre of each media object.

7. The method according to claim 5, in which the step of displaying text indicative of the one or more compatible parameters is further comprised of the step of displaying text indicative of the one or more compatible parameters overlying the visual images associated with each media object.

8. The method according to claim 1, in which the one or more parameters are comprised of ID3 tag information.

9. The method according to claim 1, in which the step of providing a visual image associated with each media object is further comprised of the step of providing a visual image associated with each media object that has an appearance that is dependent upon the number of visual images displayed.

10. The method according to claim 9, in which the step of providing a visual image associated with each media object is further comprised of the step of providing a visual image associated with each audio recording having a size that is dependent upon the number of visual images displayed.

11. The method according to claim 2, in which the step of providing one or more parameters associated with each media object is comprised of the step of providing at least a first parameter and a second parameter associated with each media object and the step of displaying the visual images associated with each media object having one or more compatible parameters in a contiguous arrangement is comprised of the steps of:
displaying visual images associated with each media object having compatible values of the first parameter contiguously within a first region; and
displaying visual images associated with each media object having compatible values of the second parameter and the first parameter contiguously within a subset of the first region.

12. The method according to claim 1 wherein the step of providing a visual image associated with each media object comprises providing a default image identifying one or more parameters associated with the media object.

13. The method according to claim 11 further comprising the step of providing the user with the ability to select the first parameter and the second parameter from among the one or more associated identifying parameters.

14. The method according to claim 1 wherein the step of displaying a visual image further comprises the step of displaying a visual image which represents a plurality of media objects.

15. The method according to claim 2 which method further comprises the step of displaying a viewable line separating contiguously displayed groups of visual images.

16. The method according to claim 1 wherein the visual image comprises a default image which is displayed when artwork associated with a media object is unavailable.

17. The method according to claim 16 wherein the default image includes text identifying a media object title.

18. The method according to claim 1 wherein the media objects comprise audio recordings.

19. A method for displaying the contents of a collection of audio recordings where the recordings are stored in a digital format on a randomly accessible storage medium and where each stored audio recording has an embedded tag identifying at least the audio recording title, recording artist, album title, year and genre of each stored audio recording, said method comprising:
providing a visual image representing each audio recording; and
displaying the entire collection of audio recordings by grouping together in one or more clusters visual images representing audio recordings having the same genre;
whereby the user is presented with a topographical image representing the collection of audio recordings in a manner which permits the user to immediately perceive the relative size of the collection sorted by genre.

20. The method according to claim 19 wherein each visual image is a colored square.

21. The method according to claim 20 wherein each visual image is an image corresponding to the cover artwork of a compact disk or record album.

22. The method according to claim 19 further comprising the steps of selecting a cluster and displaying the selected cluster by grouping together in one or more sub-clusters those visual images representing audio recordings having the same sub-genre.

23. The method according to claim 19 further comprising the steps of selecting a cluster and displaying the selected cluster by grouping together in one or more sub-clusters those visual images representing audio recordings having the same artist.

24. A method for displaying the contents of a collection of audio recordings where such recordings are stored in a digital format on a randomly accessible storage medium and where each stored audio recording has an embedded tag including at least two parameters identifying each stored audio recording, said method comprising:
providing a visual image representing each stored audio recording; and
displaying the entire collection of audio recordings by grouping together in clusters those visual images representing audio recordings having the same primary parameter;
whereby the user is presented with a topographical view of the collection of audio recordings in a manner which permits the user to immediately perceive the relative size of the collection by genre.

25. The method according to claim 24 further comprising the steps of selecting a cluster and displaying the selected cluster by grouping together in a sub-cluster those visual images representing audio recordings having the same secondary parameter.

26. The method according to claim 25 further comprising the step of selecting the first parameter and the second parameter.

27. A method for displaying the contents of a collection of audio recordings where such recordings are stored in a digital format on a randomly accessible storage medium and where each stored digital recording has an embedded tag identifying at least two characteristics of each stored audio recording, said method comprising:
generating a visual image representing each audio recording;
selecting a first characteristic and a second characteristic which, in turn, determine the manner in which the collection is displayed to the user;
displaying the entire collection of audio recordings by grouping together in clusters the visual images representing audio recordings having the same characteristic corresponding to the first selected characteristic; and
providing the user the ability to select any displayed cluster toward displaying the selected cluster by grouping together in sub-clusters the visual images representing audio recordings having the same characteristic corresponding to the second selected characteristic.

28. The invention according to claim 27 wherein the characteristics are selected from the group consisting essentially of: song title, artist, album title, year and genre associated with each stored audio recording.

29. The method according to claim 27 wherein the step of displaying a corresponding cluster by grouping together in sub-clusters the visual images representing audio recordings having the same characteristic corresponding to the second selected characteristic is repeated until reaching a last user selected parameter characteristic.

30. A method for displaying the contents of a collection of audio recordings where each digital audio recording has an embedded tag identifying at least two parameters of each audio recording, said method comprising:
generating a visual image representing each audio recording;
displaying the entire collection of audio recordings by grouping together visual images representing audio recordings having the same primary parameter.

31. The method according to claim 30 further comprising the step of displaying a selected cluster by grouping together in a sub-cluster those visual images representing audio recordings having the same secondary parameter.

32. The method according to claim 31 wherein the at least two parameters of each audio recording are selected from the group consisting of essentially of: genre, sub genre, album title, release date and song title.

33. The method according to claim 30 wherein the embedded tag comprises ID3 tag information.
